(19) United States
(12) Patent Application Publication
(10) Pub. No.: US 2002/0063912 A1
(43) Pub. Date: May 30, 2002

(54) Personalized stoneless holographic jewelry and method of its production and use

(76) Inventor: Joseph S. Barbanell, Alameda, CA (US)

Correspondence Address: Joseph S. Barbanell, 909 Marina Village Parkway, Box 436, Allameda, CA, 94501, US

(21) Appl. No.: 09/726,675

(22) Filed: Nov. 29, 2000

(51) Int. Cl. G03H 1/00; G03H 1/02; G03H 1/26

(52) U.S. Cl. 359/1; 359/2; 359/3; 359/22

(57) ABSTRACT

A personalized holographic jewelry item which has the appearance, in non-coherent light, of a precious stone (which can have the exceptional quality, clarity and size). The item preferably also includes a second hologram layer, which through use of coherent-optical processing, produces an additional positive effect. By using the principle of waveband separation, the invention enables reconstruction of personalized/security data to identify and secure said jewelry item. In other applications, the second hologram enables the item to be used as an identification device for general application, while at the same time displaying holograms of precious stones. The jewelry item might additionally include a ruby, serving, besides a display effect, the purposes both of accumulating and discharging one or more pulses of coherent radiation and at the same time being made secure by means of above mentioned security data with secure user's access. In another aspect, the invention enables the user to create/synthesize unique display holograms on biological carriers, such as nails or hair, by very simple and relatively inexpensive techniques.

### FIELD OF THE INVENTION

The invention relates, in general, to the field of display holograms and, in particular, to multiple use holographic devices which utilize means for coherent-optical processing.

### BACKGROUND OF THE INVENTION

The invention relates in its general applications to jewelry items and is intended to create a most precise effect of included precious stones. Involved for the creation of said effect, the powerful means of holography also enables creation of derivative and even more powerful positive effects.

Related art in the direct field of the inventive item in the sense of its visual display effect provide background information only and do not supply teaching directly related to the primary objects of the invention. These include, for example, U.S. Pat. No. 5,007,252 to Mochizuki; U.S. Pat. No. 5,154,047 to Takagi; U.S. Pat. No. 5,156,023 to Bevolo; and U.S. Pat. No. 5,156,022 to Altman. Typically, patents in this field discuss methods of fixing or applying ornaments or stones themselves, and do not describe novel high-tech applications of jewelry items which are features of the present invention.

In one aspect of the invention, holographic means enable additionally, by the utilization of very inexpensive production features, creation of “personalized” jewelry. These features utilize the principle of “optical waveband separation”. The novel features resulting in personalized jewelry allow the invention to serve a dual purpose.

On one hand, the created novel jewelry item, besides producing a high quality image/display effect, allows storage, reconstruction, and utilization in the jewelry item of amounts of data of the magnitude of 100 Mbt or more. Due to the utilized principle of waveband separation said data does not affect the initial display effect of the jewelry. Said features can be utilized in the capacity of general data storage or can be used for identification/security purposes.

On the other hand, this additional data can be utilized for the protection of the display hologram itself, easily verifying the counterfeiting of the latter. As a derivative application, this data can be used to protect the carrier of the display hologram, so that the jewelry item serves as a protective device for the carrier.

Utilized personalized data in such a case will protect the display hologram and will protect the carrier itself. Special cases of such a carrier are as follows: credit cards, security cards, “protective” holograms for videotapes, custom stamps, etc.

The inventor has recognized the ineffectiveness of utilizing any mass produced feature, in general, and hologram, in particular, for any kind of protection.

In view of the present invention (novel personalized jewelry, with dual application), it is helpful to clarify this point in view of recently issued U.S. Pat. No. 5,145,212 to Donald W. Mallik, issued Sep. 8, 1992 (referred hereinafter as ref. [1]), and U.S. Pat. No. 5,095,194, issued to the present inventor on Mar. 10, 1992 (referred hereinafter as ref. [2]).

In ref. [1], attempts are described to utilize mass-produced holograms to “ensure” security, including: the use of “ . . . two side-by-side. holograms, each reconstructing the separate image.” for a specific “ . . . authentication application . . . ”, which “ . . . increases the difficulty of counterfeiting the structure . . . ”.

The above-cited excerpts from ref. [1] are illustrative. It is unclear why Mallik has chosen only two and not twenty holograms to “increase further the counterfeiting” abilities of his carrier.

Any display hologram(s) can be counterfeited in real-time on the standard optical table with only low production costs for the master-dye and with production costs of only a fraction of a cent for each counterfeit copy. The application of two or twenty or even hundred side-by-side holograms can not fulfill any security purposes. Application of the hologram for security purposes should serve the following: in order to provide verification said hologram should be viewed or processed in any form.

If so, the counterfeiting technique involves for forgery the equipment of the kind intended for processing.

Technical difficulties for producing counterfeit master hologram are virtually non-existent nowadays. Therefore, for instance, the statement of ref. [1], that hidden or “buried” (see column 11, lines 5 through 15 of ref. [1]) hologram prevents forgery, is incorrect. Only two possibilities exist.

a. Said mass-produced hologram is “buried” to the extent that it can not be utilized for security purposes at all, and therefore is entirely useless; or

b. It is, yet, utilized for security purposes. In this case it can be easily forged. The forger does not need to (see line 15 and 16, column 11, ref. [1]) “ . . . physically take the hologram apart in order to replicate . . . the hologram”. Straightforward methods to produce the counterfeit master copy for the hidden in inner layer “protective” hologram of ref. [1], include utilizing for copying a laser in a waveband in which the outer layer becomes transparent. The transparency of the latter in the general sense should be made available, or the hidden hologram can not be utilized for the requested security purposes.

In general, Mallik, repeating in disclosure the description of the hologram functioning written in the classical monographs on subject, having been published the quarter of the century ago, is once again generalizing the error that mass-produced hologram can prevent the fraud.

Utilization of one hologram on a card has proven to be totally useless, counterfeit cards appearing almost instantly. The assumption of two mass-produced holograms to protect cards is equally invalid.

Moreover, such an approach contradicts the general theorems and approaches of communication systems, which state that only the enhancement of utilized data can protect channel/system.

The present invention, in contrast, supplies each novel card with an individual and not mass-produced hologram.

Of course such a card can be copied. Methods of its further protection were discussed in great detail by the inventor in ref. [2]. Said methods were made available in the inventive items due both to the simplicity and the inexpensiveness of OPTICAL storage and PROCESSING of the above-mentioned volumes of data of the magnitude of 100 Mbt or more.

In the worst case, if being copied, the novel item of the invention can not be utilized without cooperation of an authorized user, and the copying will produce the forgery of the only one card and does not enable to provide mass-counterfeiting.

The novel jewelry item also serves these purposes in special applications. Other advantages of the invention will become apparent from the detailed description of the preferred embodiment given below.

Besides above-cited ref. [2], the present invention is related to “Holographic credit card with multiple access . . . ”, U.S. patent application Ser. No. 08/097,530, filed Jul. 27, 1993 by the present inventor, and U.S. Pat. No. 5,056,880 (“Holographic Wallpaper”), which names the present inventor as sole inventor. Those are referred to hereinafter as refs. [3] and [4] respectively.

### SUMMARY OF THE INVENTION

A primary object of the invention is to create by holographic means in non-coherent, ordinary, light an exact impression (image) of a jewelry item possessing a precious stone of exceptional quality, clarity and size.

Another object of the invention is use of the principle of waveband separation to produce additionally the reconstruction of personalized/security data.

Another object of the invention is with the help of said security data to identify and secure said jewelry item.

Another object of the invention is with the help of the above principle to secure identification cards for general applications, while utilizing on them the display holograms of precious stones.

Another object of the invention is to include in the inventive jewelry item a ruby, serving the purposes both of accumulating and discharging one or more pulse(s) of coherent radiation.

Another object of the invention is to protect and personalize the access to said ruby discharger by means of said personalized access data.

Another object of the invention is to provide inexpensive approaches for production of inventive jewelry items.

Another object of the invention is to enable the user to create/synthesize himself unique display holograms on biological carriers, nails, hair, etc.

Another object of the invention is to provide an inexpensive means of copying display holograms of large size, being reconstructible in incoherent light. other objects and advantages of the invention will become apparent from the detailed description given below.

### DESCRIPTION OF THE DRAWINGS

FIG. 1 is a block diagram of mass-production of the inventive stoneless holographic jewelry.

FIG. 2 is a cross-sectional view of the inventive personalized holographic jewelry item, including personal protective features.

FIG. 3 is a cross-sectional view of activation of personal protective features in a personalized holographic stoneless jewelry item embodying the invention.

FIG. 4 is a diagram of the synthesizing of a user-applicable jewelry item.

### DESCRIPTION OF PREFERRED EMBODIMENT

The inventive system represents on the first level the generalization of the current approach of jewelry imitation, devoted to the decreasing of both the production and selling costs of the jewelry, i.e., it generalizes the method of exchanging high-valued precious stones for their imitations, cubic circonium crystals, for instance.

This approach has earned reasonable credibility, but is yet is seriously expensive, requires serious production costs, and most of all, it does not provide the perfect imitation of the initial precious stones, due to the imperfections of said crystals.

Considering widely recognized advantages of holography, which allows production of exact copy/imitations of any object, the invention realizes the generalization of the above imitation approach in the a holographic form. In other words, instead of utilizing of imitation stones, crystals, etc., the inventor suggests use of the exact and best known copy of a precious stone in the form of a corresponding hologram.

Methods of production of the inventive jewelry may be different and are discussed below, but all of them are most advantageous both in terms of production costs and the simplicity of mass-production of the novel jewelry.

Other advantages of novel generalized imitation approach, compared to the natural precious stones and even to their least expensive crystal imitations, are as follows:

a) A single master hologram can be manufactured for mass-production of the set of novel jewelry, with the magnitude of 10,000 items or more;

b) Manufacturing costs for said master hologram are very low (usually in the range of $5,000), which are seriously below the cost of any precious stone, and the production costs for each consequent jewelry item are negligible;

c) Hologram represents the best possible copy of the object, with the quality incomparably higher, then any other imitation technique, imitation crystals included;

d) Precious stones, particularly diamonds, due to their unique reflecting capabilities, serve like the best possible objects for the preparation of said master hologram. It is generally recognized, that holograms of precious stones create the image practically of the same quality as the initial precious stones. Of course said precious stones are not being damaged in any form during the process of master hologram preparation;

e) Simplicity and inexpensiveness of said master hologram manufacturing allows one to use for it precious stones of the best possible quality and very large size. Impressiveness of such an object allows one to utilize the master hologram of a size not exceeding the size of the initial stone, i.e., to decrease further production costs. The novel jewelry with a hologram will create, as a result, the total and unsurpassable impression of presence of a huge precious stone with the best possible quality in said jewelry item;

f) The features mentioned in e) allow one additionally to utilize and manufacture the widest possible selection of different precious stones, their combinations and setting, i.e., to easily cover the total jewelry market by producing both the extremely impressive and inexpensive imitation jewelry;

g) The media for “mounting” said precious stones' holograms can either be precious metals or, at least, a precious metal coating. Those do provide the best reflecting surfaces for hologram reconstruction, both in terms of quality and brightness. Therefore, the suggested novel approach provides, on one hand, the best possible objects for hologram manufacturing (precious stones) and on the other, assures the best surfaces for the their reconstruction (precious metals, standardly possessing the best reflecting capabilities;

h) All involved methods and procedures of jewelry mass-manufacture do not damage utilized precious metals. Considering additionally the negligibly low costs of production, said metals can be remelted to be used further for another types of novel imitation jewelry or for another conventional applications; and

i) The standard conditions for the utilization of the novel jewelry are additionally the best ones for hologram reconstruction. Those include daylight, intense illumination for scene performance, and even candlelight.

Said itemized advantages separately and in combinations ensure the incomparable positive effect of the novel application for the general jewelry market.

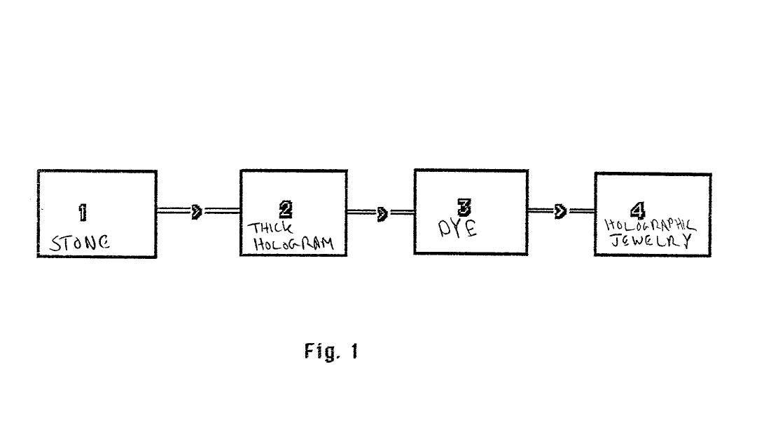

Processes of preparation of the master hologram and its application for mass-production of jewelry is recognized and in its straightforward form can be represented by the diagram of the FIG. 1.

The precious stone of the best possible quality, with or without settings, —1 is being used like an object for the optical thick hologram—2. The latter serves for the production of the embossing dye 3. This dye is being utilized for the mass-production of the jewelry 4 by the direct embossing on the precious metals, or the metals corresponding coatings.

Such straightforward production procedure is highly developed even for the case of metal-foil embossing. In the case, if the embossing on curved thick surfaces creates technical problems, the embossing can be performed on flat foil, which later is being glued, soldered, or otherwise fixed to the corresponding jewelry item.

Alternative derivative production procedures for the curved jewelry surfaces might conclude not in embossing but in “burning down” said hologram with the application of standard procedures utilized in optical discs' production industry.

Special cases of jewelry with curved (concave) surfaces might provide particular interest, being utilized in conjunction with U.S. Pat. No. 5,056,880, issued Oct. 15, 1991, naming the present inventor as sole inventor, and related to wall-paper. In the latter the invention considered in great detail the method and corresponding application of small size holographic dyes repetitively used for the large size holograms. Disadvantages itemized therein related to the usage of laser illumination and relative complexity of the corresponding scanning system. In the particular application under discussion (holographic jewelry) neither of said disadvantages exists.

If the considered reflecting surface of the jewelry item will possess the definite curvature in the form of the spherical surface, then the embossed hologram should compensate said curvature, i.e., should be produced in the form of Fourier-hologram.

Processes of preparation of such thick hologram should include additional spherical lens, being situated in the object beam. The corresponding small-size dye will be advantageous. The above-itemized disadvantages of this approach are absent in the present jewelry application:

a) a scanning system is not needed, due to the utilization of a single hologram for a single jewelry item, and

b) reconstruction is realized in non-coherent light.

An additional advantage of a spherical surface embodiment of the invention is that the considered spherical curvature is the most “natural” one for the embossing techniques and can be realized during embossing process by supplying the inverse curvature to the embossing dye.

Returning to the wall-paper disclosure, the derived novel suggestion to utilize thick Fourier-holograms along with the straightforward method of their manufacturing, allows one to realize the non-coherent reconstruction of said wall-paper and therefore greatly simplify the illumination system. The latter becomes greatly advantageous in terms of simplicity, costs, output energy, is devoid of negative laser-light influence on the viewers, etc.

The approach of the present invention, though possessing the set of mentioned major advantages, can be further improved with utilization of powerful means of holographic processing.

Keeping in mind, that the above-discussed thick holograms are reconstructed in non-coherent light, using the possibility of the light waveband separation and already used concept of Fourier-hologram utilization, the inventor suggests including in the jewelry a second holographic layer, i.e., to produce a two-layer hologram.

The second layer, to provide data-separation, in such a case, should be represented as a thin-layer, or coherent hologram. This second layer is intended to be devoted not for display purposes, but to carry service information.

The latter can be any general information data, history of the particular jewelry item, for example, or can carry the data about the user, i.e., to become personalized.

In a straightforward application this second thin layer hologram might be represented as a Fourier hologram of biometric data, a fingerprint, for instance.

In the special case of the curved reflective surface of jewelry item(s), discussed above, the recognition application becomes the most advantageous one, enabling one to eliminate a focusing lens in an approval device for the recognition purposes.

Such personalized jewelry, utilizing the concept of light waveband separation, works in the following way:

The manufactured jewelry item, while being illuminated by non-coherent light, will create the desired and perfect impression of the precious stone included. But being illuminated by a coherent beam, the same item will reconstruct the service data or the data for personalized identification, or both.

The exceptional data storage/processing capabilities of such an data carrier, easily exceeding 100 Mbt, should be kept in mind.

The sequence of application of the inventive separate layers is not important, though in terms of production simplicity, the inventor suggests that the thin-layer hologram should cover the display hologram.

This second, informative, layer will additionally serve the purpose of a protective coating for the display hologram, itself not being subjected to the mechanical damage.

Manufacturing of such an jewelry item can be performed as follows:

After the step of embossing of the display hologram on the particular jewelry item, the latter is covered by separately prepared personalized data-carrying hologram. Positioning of the latter has no importance on the further step of personalization identification. On the other hand, with the help of the above principle it becomes possible to secure identification cards for general applications, while utilizing on them display holograms of precious stones.

For mass production of novel personalized jewelry, the inventor suggests a “strategic” production method, in which the embossed display hologram is covered by the thin thermoplastic crystal layer. Not being activated by the electric signal, said layer serves only the protective purposes and can stay dormant for an indefinite period of time. But being activated, it can register and store the requested personalized data for the period 6 month plus with the resolution of 1000 lines/mm plus.

The single disadvantage of the approach is in the relative expensiveness of such crystals nowadays.

Mentioned above the 6-month period of storage can be enhanced by the consecutive charging of the crystal. On the other hand, the “recharging” ability of such a carrier enables operatively change, even by consumer the stored personalized data.

Such a personalized jewelry can, while returning to the security applications, serve the purposes of totally eliminating the existing fraud, while, yet, preserving the existing mass-produced holograms on the security cards, for instance. The latter is valid also for application of thick holograms to the fields of protecting products of any sort, videotape, for instance, i.e., serving the purposes of a “protective” trademark.

Once again, it should be reminded, that thick display holograms in any security applications do not provide any protection. Such a hologram can be easily duplicated and forged holograms can be straightforwardly forged in practically unlimited volumes in real-time.

The inventive multilayer device by utilization of security data can protect the thick-layer hologram thereof from forgery and additionally can protect the product, which the latter was supposed to protect initially.

To decrease production costs and simplify the production process for this application the special subcase can be implemented. The inventive thin-layer hologram can be considered to be mass-produced also and can include in this case personalized data about a limited number of authorized users, the heads of corresponding companies, for instance.

Of course, this approach is not advisable, in general, due to the corresponding decrease of security level, but for the discussed limited application, it can be considered.

Concluding this application, it should be emphasized once again, that only optical storage/processing enables one to provide the required security level in the current state of the art.

Any kind of magnetic security storage can be easily rerecorded, even in the presence of user/customer. A PIN (personalized identification number) in its modern form (4-6 decimal digits, i.e., 16-24 bits) can be broken by a computer in milliseconds.

The optical approach utilized by the inventor, of course, does not protect from rerecording/copying. But in order to break down the utilized inventive “PIN” with 2 Mbt (2 Megabytes) or more of data will require days of computer time. During this period the lost/stolen identification item, in the form of the inventive jewelry, will be reported by the user and inexpensively changed.

The inventive jewelry item with utilization of waveband reconstructed data separation provides, additionally to the display purposes, unique personalization features and enables one to incorporate in jewelry absolutely unique features, not considered before.

For the below-described application one should consider the following unique properties of precious stones, such as rubies. Being utilized not only for the display purposes and being additionally specially cut, those represent carriers for production, storage, and release of single laser pulses.

Therefore the particular jewelry item, if it includes a ruby of a reasonable size, artificial if necessary, will hold energy for providing a laser pulse of considerable energy and seriously large energy density.

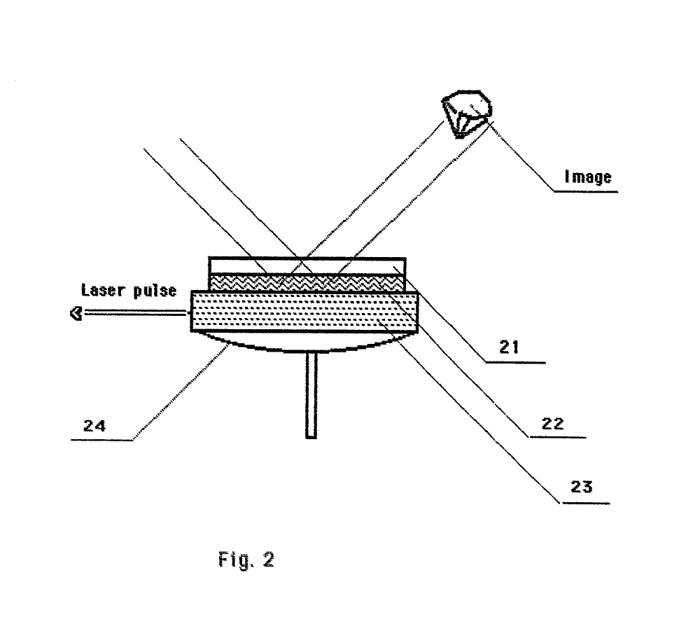

Such a ruby can be embossed further by the inventive holographic layer(s), will include (see FIG. 2) the thin layer hologram 21, thick hologram 22, ruby 23, and reflecting jewelry item base 24.

It will create (see FIG. 2):

a) in ordinary (non-coherent) light—the impression of a ruby with huge diamond/emeralds included, which is created by combination of 23 and 22;

b) in coherent light—provide personalized data, or approval data, which is provided by layer 21; and

c) being activated, by utilization of layer 21, it can serve in the capacity of a personalized protective device, by causing a laser pulse to be emitted from layer 23.

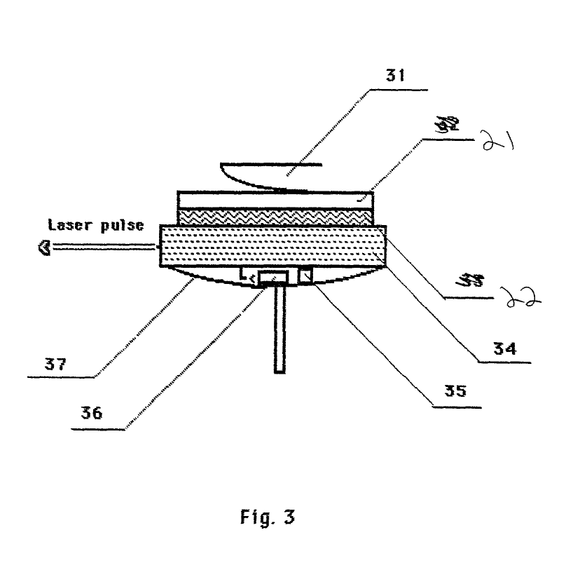

Activation of such a jewelry item in its laser pulse emission capacity can be made absolutely personalized and foolproof, by using included in the thin-layer hologram protective personalized data. Activation can be realized (see FIG. 3) by straightforward generalization of inventor's approaches, which were discussed in ref. [2], by utilizing the user's fingerprint 31, for instance, and is not repeated in detail in the present disclosure. For said activation the jewelry item should additionally include auxiliary laser 35 and photodiode 36 which provide feedback to ruby layer 34 for triggering generation of a laser pulse in layer 34. Layers 21 and 22 are identical to corresponding layers in FIG. 2.

Small-power continuous approval laser 35 should not be confused with the pulse ruby laser 34, the latter being activated by the former.

Due to the novel suggested concave reflecting base surface 37 for activation the item does not require an additional Fourier-transforming lens, said surface 37 fulfilling necessary transforming functions. Therefore for the application under discussion even the physical structure of the personalization device simplifies further.

Summarizing, the inventive jewelry item becomes foolproof in terms of possibility of its activation by the designated user/owner only.

Charging of a ruby included in said personalized jewelry item can be realized independently, by the recognized and developed in laser applications methods and does not represent any technical difficulties.

Such a jewelry item, while being realized, like a tiara, for instance, enables one to provide the multipulse protective device, which additionally possess all necessary both the display and the protective features. Such jewelry items are additionally totally recoilless and therefore do not involve danger for the user(s).

Therefore, suggested novel multilayer holographic approach to jewelry production/utilization provides totally nonevident features in terms of the display capacity, technical and protective features.

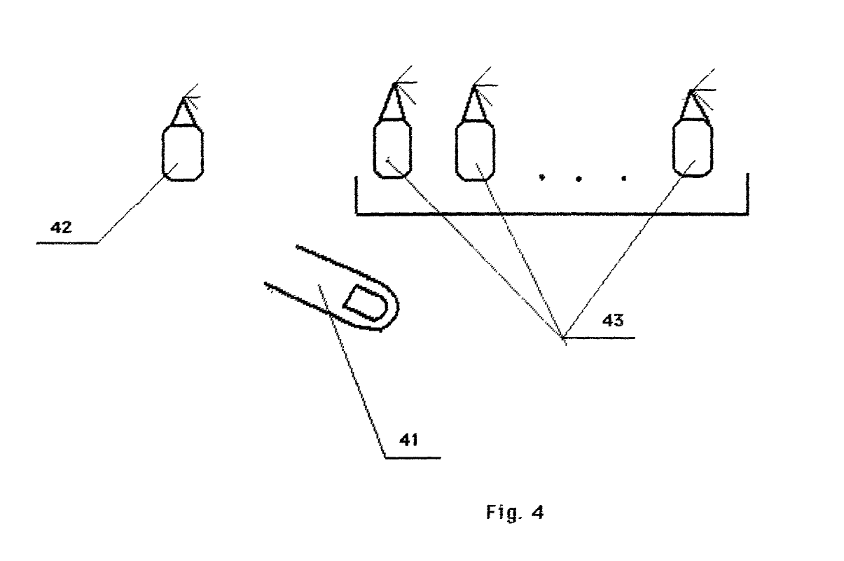

In conclusion, the special case of holographic jewelry should be discussed. Because a reflecting surface/base is not essential, the inventor suggests that one apply the holographic layer(s) 43 directly to the jewelry user 41, i.e., to her/his nail, for instance (see FIG. 4).

In such an application, a thick layer hologram 42 of the same sort as layer 22, is being “constructed”, or synthesized in real-time on the user by spraying or otherwise applying the different coatings 43 comprising hologram 42. These coatings can consist of the conventional coatings for lens-industry applications and can included in the spray bottles, for instance.

Advantages of such a method, compared to the lens industry, the coating of which are utilized, are as follows:

a) precision of “spraying” for separate layers, number of said layers, etc., for each nail and from nail to nail is not needed. The more imprecise are the coatings, the better is the display effect;

b) the coating need not be time-stable. For them it is better to be unstable, to become washable or even self-evaporating in the period of 2-6 hours;

c) the coatings should provide the best possible coloring effect, positively being avoided in said lens industry; etc.

All these features allow one directly to utilize lens coatings, in general, and those considered not to be adequate for said industry, in particular.

The general display effect of this particular jewelry application which becomes user-synthesized and totally unique, will not to create the effect of the diamond to be displayed, but to provide the sparkling effect of the kind which can be represented by the surfaces of the conventional optical discs, i.e., to create the impression of sparkling “rainbow” from each separate nail.

Said effect will be further enhanced by the constant movement of fingers, providing in time and in space multiple positioning of the reflective surfaces.

Therefore such a jewelry item, which can be realized, for instance, like a self-applicable sprayable nail-polish, is named by the inventor “the rainbow on your finger”.

For this specialized jewelry application inventor suggests user-synthesized multilayer thick hologram, produced by sprayable application of media, considered nonadequate for the conventional lens-coating industry, and therefore becoming relatively inexpensive.

To enhance said display effect the novel spray set can include a separate container with the particularly reflecting substance, the silver or gold reflecting paint, for inst. Further to enhance the effect, the set can include special patterns, utilized by the user in the process of spraying.

As a curiosity feature, such a nail-jewelry item can additionally include thin-layer holograms of the same sort as 21, carrying personalized data and being applied by sticking/gluing on the surface of the outer sprayed layer. Such hologram enables the user to carry said security data on the nails, activating it when necessary.

For the constructed rainbow effect said layer will serve the purpose of the protective layer, protecting, for instance, the display constructed multilayer hologram from the evaporation process. After this cover layer being unglued, for instance, said self-evaporation process of the rainbow hologram will be self-activated.

Rainbow jewelry under discussion can additionally include in the inner layer a thick hologram of the precious stone, either separately or with the discussed above layers, creating additionally the impression of faultless, exceptional quality stone being present on each nail.

The application of the above-discussed coating layers need not necessarily be in said “sprayable” modification. Those can be applied by conventional means, a brush, for instance. The latter application, however, is absolutely unadvisable, due to the special elements, i.e., heavy metals, involved in solutions to be applied.

Yet, those can be envisioned to be included in squeezable containers, partially hermetic containers with the tip-felt brushes, etc.

In conclusion the following should be made clear: diamonds, emeralds, etc. represent the best objects to be “holographed”. Therefore they are most advisable to be used as the masters for the thick-layer holograms for novel jewelry. In general cases, of course, any object can be utilized to be incorporated in the form of a hologram in the novel jewelry. Novel jewelry covers additionally such an application as production personalized tailor-made exact imitations of the existing jewelry items.

In related applications, the novel jewelry, while being directly “printed” on flexible materials of the kind of plastic metal coated rolls, fabrics with plastic coatings, etc., can be utilized for production of clothing of different kinds.

### SUMMARY

Invention relates, in general, to the field of the display holograms and is intended to create in ordinary light by the use of holographic means the exact impression of jewelry item to possess the precious stone of the exceptional quality, clarity and size.

In more general applications the purpose of said item is by the use of coherent-optical processing means is to produce the additional multiple positive effects. By using the principle of waveband separation (i.e., selective response of one layer to one type or “bandwidth” of radiation, such as coherent radiation, and selective response of another layer to another type or “bandwidth” of radiation, such as non-coherent radiation), it enables additionally to reconstruct the personalized/security data, and by the use of the latter both to identify and to secure said jewelry item. In other applications the achieved effect enables one to secure identification cards, credit cards, personal checks, and even the jewelry item itself, etc., while utilizing on them at the same time display holograms of precious stones.

The inventive jewelry item might additionally include a ruby, serving in the inventive application, in addition to the display effect, the purposes both of accumulating and discharging one or more pulse(s) of coherent radiation and at the same time being made secure by means of above mentioned security data with secure user's access.

The inventive approach in a special case enables additionally the user to create/synthesize by himself the unique display holograms on biological carriers, such as nails, hair, etc., by very simple and relatively inexpensive means. The latter can include spray application, felt-tip squeezable containers, etc., or might be performed in the conventional form of bottles with brushes.

What is claimed is:

1. A personalized stoneless holographic jewelry item, including: a hologram comprising at least two hologram layers, wherein each of the layers is selectively responsive to a different radiation type, wherein the item utilizes bandwidth separation of reconstructed informative data.

2. The item of claim 1, wherein one of said layers is an embossed thick-layer hologram of a precious stone, and a second one of the layers is a thin hologram of personalized security data.

3. The item of claim 2, wherein said thin hologram is a Fourier-hologram.

4. The item of claim 2, wherein the thick hologram includes a precious stone setting.

5. The item of claim 2, additionally including: an inner layer comprising a solid state ruby.

6. The item of claim 4, wherein the inner setting is realized with a curved surface.

7. The item of claim 6, wherein said curved surface is a concave one, possessing properties of a spherical lens.

8. A method of activation of multilayer holographic stoneless personalized protective jewelry, comprising the steps:
a) supplying biometric data to an outer personalization thin layer hologram of the jewelry;
b) activating by said data an approval signal;
c) feedbacking said signal to a inner ruby layer of the jewelry;
d) activating by said signal a laser pulse response from said inner ruby layer.

9. A method of production of a multilayer holographic stoneless personalized jewelry, comprising the steps:
a) embossing a thick-layer hologram on a base; and
b) covering the thick-layer hologram by a thin-layer hologram.

10. A method of production of multilayer holographic stoneless personalized protective jewelry, comprising the steps:
a) applying a ruby layer on a base;
b) applying an auxiliary laser and a photodiode on the base;
c) embossing a thick-layer hologram on the ruby layer;
d) covering the thick-layer hologram by a thin-layer hologram.

11. A method of production of a multilayer user-applicable personalized holographic stoneless jewelry, including the steps of: consecutive multilayer spraying of a biological carrier with lens-coating substrates to define a thick-layer hologram; and covering the thick-layer hologram with a thin-layer hologram.

12. The item of claim 2, wherein the thin hologram is a user activated thermoplastic thin rechargeable crystal.

13. The item of claim 1, wherein the number of layers is less than three.

14. A personalized stoneless holographic jewelry item, including a base; at least one hologram layer on the base, each said layer being selectively responsive to a different radiation type.

15. A multilayer user-synthesized holographic stoneless jewelry item, comprising: consecutively sprayed layers of lens-coating substrates.

16. The item of claim 15, said item having a rainbow appearance, and additionally including an outer thin-layer hologram protective coating encoded with personalized security/informative data.

17. The method of claim 11, wherein the carrier is a user's nails.

18. The method of claim 11, wherein the carrier is a user's hair.

19. The item of claim 6, wherein the thick hologram is realized as a Fourier-hologram.

20. The item of claim 19, wherein the thick hologram includes a set of identical hologram components, which in conjunction with a non-coherent scanning illumination system create an image of a large size display hologram.

21. The item of claim 2, wherein the thin hologram is encoded with security data of a predetermined limited number of authorized users.
